(19) United States
(12) Patent Application Publication
(10) Pub. No.: US 2008/0312898 A1
(43) Pub. Date: Dec. 18, 2008

(54) Method and a System for Network Management Information Representation

(76) Inventors: David Cleary, Athlone (IE); Boris Danev, Zurich (CH)

Correspondence Address: COATS & BENNETT, PLLC, 1400 Crescent Green, Suite 300, Cary, NC, 27518, US

(21) Appl. No.: 12/096,317

(22) PCT Filed: Dec. 5, 2005
(86) PCT No.: PCT/EP2005/056488

§ 371 Date: Jul. 9, 2008

(51) Int. Cl. G06G 7/62; G06N 5/02

(52) U.S. Cl. 703/21; 706/47

(57) ABSTRACT

The present invention relates to a system for representation of network management information, comprising a network management system represented through a machine-readable basic network information model comprising a number of network elements with a number of managed objects with instances, and an external network management interface (10). It comprises first mapping means (1) adapted to generate mapping rules for mapping the machine-readable basic network information model to a formal ontology based network information model, information enrichment means (2) for manually and/or automatically enriching the information of the formal ontology based model semantically, thus providing a semantically enriched formal ontology based network information model, processing means (3) adapted to receive the mapping rules from the first mapping means (1), network instance data represented by a generic mark-up language from the external network management interface, and the semantically enriched formal ontology based network information model. The processing means are adapted to automatically instantiate the semantically enriched formal ontology based model using said mapping rules and to transform the enriched formal model comprising instances and ontologies to formal logic statements. The system also comprises a formal model storing means (5) for storing the formal logic statements, forming a semantically extended configuration-aware external network management interface (20).

### FIELD OF THE INVENTION

The present invention relates to a system for representation of network management information and comprising a network management system represented through a machine-readable basic network information model comprising a number of network elements, each comprising a number of managed objects with managed object instances, and an external network management interface. The invention also relates to a method for representation of network management information of a management system represented through a machine-readable basic network information model, comprising a number of network elements, each with a number of managed objects with managed object instances, and an external network management interface.

### STATE OF THE ART

The TeleManagement Forum (TMF) is standardizing a next generation operation system and support, NGOSS, for defining, for service providers and their suppliers, a comprehensive, integrated framework for developing, procuring and deploying operational and business support systems and software. NGOSS is provided as a set of documents making up a toolkit of industry-agreed specifications and guidelines covering key business areas and technical areas and defined methodology for using the tools. NGOSS uses a “Lifecycle” approach to development of management systems, based on clear definitions of business processes, specifications and architecting software and systems to automate those processes in a technology independent manner.

The ability to integrate network management systems forms the basis for construction of a successful OSS (Operation System and Support) and BSS (Business Systems and Support) system for telecommunication operators. Such an integration is however a costly activity requiring considerable tailoring and adoption of systems. Current application integration in 3G Network Management Systems (NMS) is achieved using machine interfaces (CORBA) and XML representation of the network data represented in a Managed Object Model, MOM, which is an object-oriented high-level abstraction of entities being managed in the network.

Enterprise Application Integration (EAI) is a software architectural discipline that is commonly used to describe system integration activities of the above mentioned kind. Historically EAI solutions have revolved around priority adoptions of applications and the use of middleware frameworks such as CORBA, MQseries etc. In today's business to business online application development the concepts of EAI have been adapted and generalised for use on the Internet, which actually forms a new field of computing most commonly referred to as a service-oriented architecture, SOA. Even if SOA is a software architectural concept, the de-facto realisation of it today is based on Web services and the Simple Object Access Protocol (SOAP).

Web services provide a standard means of interoperating between different software applications, running on a variety of platforms and/or frameworks. Web services are characterized by their great interoperability and extensibility, which mainly is due to the use of XML (Extensible Markup Language), and they can be combined in a loosely coupled way in order to achieve complex operations.

Programs providing simple services can interact with each other in order to deliver sophisticated added-value applications. Along with the development of Web services, the requirements for smart representations of the services and service data for intelligent manipulation such as discovery and retrieval of information are becoming higher.

The Semantic Web is a concept providing a common framework allowing data to be shared and reused across applications, enterprises and community boundaries. The Semantic Web centers the framework on ontologies for representation of information. Ontologies are taxonomies of concepts and their attributes in a given domain together with the formal representation of domain assumptions. Formal here means that it is semantically rich and based on a well-understood logical paradigm. Formal ontologies are hence based on well-defined semantics enabling machine-readability and reasoning about information.

Telecommunication equipment vendors have standardised the integration of Network Management as specified by 3GPP (Third Generation Partnership Project) focusing on representation of management data with little or no semantic information in a technology neutral manner, providing a mapping to various solutions sets. These solution sets are mainly based on CORBA and XML. However, the interface definition is limited to being centred on a syntactical specification. The problem with large scale Enterprise Application Integration (EAI) and NMS integration to OSS and BSS systems resolved around the meaning of the information. 3GPP has for example standardized some syntactical constructs in the network management model, but despite that there are many vendor proprietary constructs. As an example, there could be two vendor specific statements with standard and proprietary constructs as follows:

{node=RNC, name=Athlone, network=Vodafone, vsDataContainer=UniSaalProfile, attributes=maxStat}
which is semantically equivalent to:
{node=RNC, name=Athlone, network=Vodafone, vsDataContainer=UniSaalDefinitions, attributes=mStat}

However, these two sets of information are partly syntactically equivalent due to standardization efforts, but they are also use vendor specific vocabulary to describe non-standardized information or management concepts. This is a problem which complicates interoperability or integration with service-oriented Enterprise Application Integration solutions in a flexible way without affecting the implementations of current NMSs.

### SUMMARY OF THE INVENTION

What is needed is therefore a system as initially referred to which enables integration of network management systems (NMS), particularly existing or current management systems, with existing or a future service-oriented architectures. Particularly a solution is needed which allows bridging of current management systems to service-oriented architectures without affecting the current NMS implementations. A system is also needed which allows an easy integration of NMS systems to service-oriented architectures such as Web services or Semantic Web services. Particularly a solution is needed which is applicable in a multivendor system environment. Even more particularly a system is needed which uses and encapsulates current standards, such as for example 3GPP and W3C standards. Particularly a system is needed which can be used for Future Enterprise Application Integration (EAI) based on service-oriented architectures, which e.g. are based on smart web services which particularly evolve quickly and change the specifications, without affecting the network management system.

A particular object of the invention is to provide an NGOSS system and providing an architectural process to extend the life cycle of existing NMS/EMS system. It is particularly an object to provide an external network management interface, which in an easy and flexible manner enables integration of a management systems with new and/or evolving service-oriented architectures.

Therefore a system as initially referred to is provided which comprises first mapping means adapted to generate or establish, e.g. create or fetch, mapping rules for mapping the machine-readable basic network information model to a formal ontology based network information model, information enrichment means for manually, or allowing manual and/or automatical, enriching of the information of the formal ontology based model semantically to provide a semantically enriched formal ontology based network information model, processing means adapted to receive mapping rules from the first mapping means, network instance data represented in a generic mark-up language from the external network management interface, and the semantically enriched formal ontology based network information model, and to automatically instantiate the semantically enriched formal ontology based model using said mapping rules and to transform the enriched formal ontology network information model comprising instances ontologies to formal logic statements.

The system further comprises a formal model storing means for storing the formal logic statements, said storing means containing a semantically enriched machine-readable representation of the network management system model forming a semantically extended configuration-aware external network management interface.

The basic network information model particularly comprises an information model representation based on UML, Unified Modelling Language.

In an advantageous implementation the UML representation should be exchangeable according to the OMG (Object Management Group) XMI (XML Metadata Interchange) standard e.g. version 2.0.

The first mapping means are particularly adapted to perform a mapping of the UML representation (or any other similar representation) to a given ontology language syntax. Particularly the ontology language syntax is OWL (Ontology Web Language) or F-logic. The enrichment means are particularly adapted to add information invariants on properties, concepts and/or relationships comprising network domain information. In addition thereto the added information may comprise network model manipulation information to be used for providing network configuration task flow generation.

Particularly the network instance data is represented based on 3GPP Bulk XML IRP. The external network management interface particularly comprises the so-called Northbound network management system (NMS) interface and provides network instance data according to the 3GPP Bulk XML IRP. Reference is hereby made to 3GPP TS 32.615 v5.5.1 (2004-12), particularly chapter 4.1 and chapter 4.3, pages 12-13.

In one implementation the formal logic statements representing the instances and ontologies in the ontology language syntax are expressed using Description Logics. Alternatively Frame Logics (F-logic) is used. The system particularly provides a semantically extended configuration-aware external network management interface which is adapted to provide a bridge between the network managing system and external service-oriented architectures (SOAs).

The invention also suggests a method as initially referred to which comprises the steps of;

providing a representation of a basic network information model in a machine-readable form from an external network management interface to first mapping means;
generating, e.g. creating or fetching, mapping rules for the mapping of the representation of the basic network information model to a formal ontology based network information model in a given ontology language syntax;
forwarding the provided, e.g. generated or fetched, mapping rules to a processing means;
storing the mapping rules in the processing means;
enriching the formal ontology based model semantically to provide an enriched formal ontology based network information model.

It should be clear that the order of the last three steps can be any one and/or one or more of the steps can be performed simultaneously etc.

The method further comprises the steps of;

providing the enriched formal ontology based network information model to the processing means, and;
providing network instance data from the external network management interface to the processing means;
using the mapping rules and the network instance data stored in the processing means to automatically instantiate the enriched formal ontology based network information model in said processing means, hence providing a formal representation of the network data;
storing the formal representation of the network data in formal model storing means, hence providing a semantically extended configuration-aware, external network management interface.

In a particular embodiment the basic network information model comprises an UML information model representation which here particularly follows the OMG XMI standard.

The mapping rules generation step particularly comprises; mapping the UML representation (or any other relevant, similar representation) to a given ontology language syntax.

The enriching step particularly comprises adding information invariants on properties, concepts and/or relationships comprising network domain information. This is particularly performed manually or partly manually although it could also be provided for automatically.

The enriching step further comprises, in a particular embodiment, adding network model manipulation information for generation of configuration task workflows, which particularly also is done at least partly manually.

The network instance data particularly comprises Bulk XML data and the external network management particularly comprises a Northbound NMS interface.

The method preferably comprises the step of, in the processing means, using Description Logics, or alternatively Frame Logics, to express the formal logic statements representing the instances and ontologies in the ontology language syntax.

Most particularly the method also comprises the step of storing the formal representation of the network data expressing formal logic statements, for example Description Logics or Frame Logics, in formal model storing means hence comprising a semantically enriched machine-readable network model representation. Still further the method advantageously provides a bridge between the network management system and external service-oriented architectures using the enriched machine-readable network model representation as a semantically extended configuration-aware external network management interface.

Although, the invention particularly provides a way to build an enriched network management model, it enables integration with smart service oriented EAI solutions in a highly flexible way on top of the EMS standards, without affecting the core of current NMS implementations.

Particularly, according to the invention, a number of architectural steps or processes are provided which have an easy, highly automated way to expose semantically enriched network management system Northbound interfaces for use in next generation service-oriented architectures for example based on smart web services, without affecting the core of current NMS implementations. This means that existing NMS systems easily can be integrated into operators' business processors without requiring any redesigning of the current systems.

### BRIEF DESCRIPTION OF THE DRAWINGS

The invention will in the following be more thoroughly described, in a non-limiting manner, and with reference to the accompanying drawings, in which:

FIG. 1 shows a block diagram of a network management system information representation system according to the invention,

FIG. 2 is a block diagram similar to FIG. 1 but wherein the required steps are indicated, and

FIG. 3 is a flow diagram describing the procedure according to one implementation of the present invention.

### DETAILED DESCRIPTION OF THE INVENTION

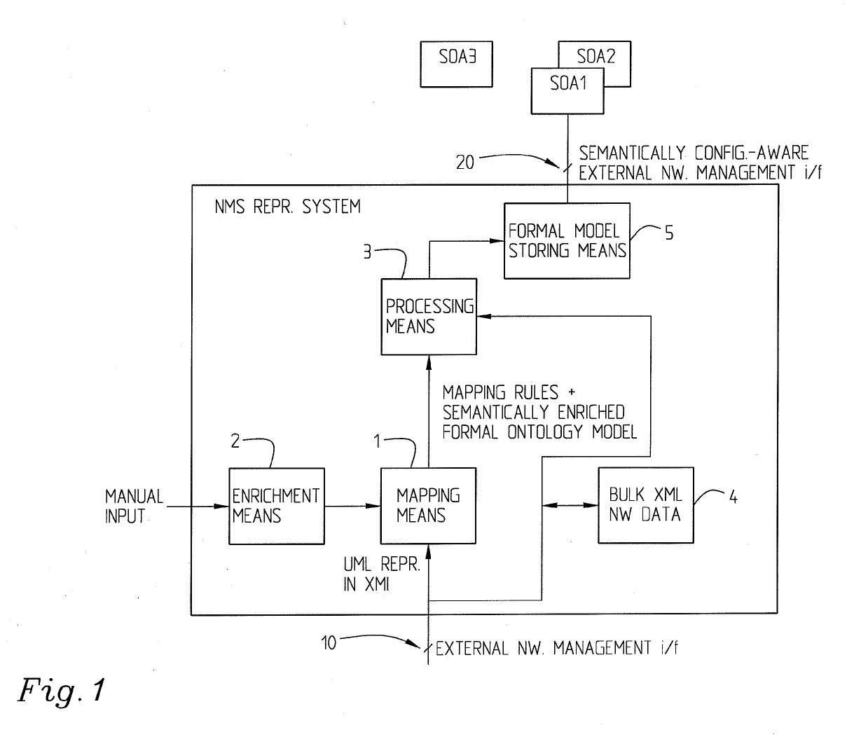

FIG. 1 is a block diagram describing an NMS representation system according to the present invention with an external network management interface 10 in a conventional manner which may comprise a so-called Northbound NMS interface. A Northbound NMS interface is a for example described in 3GPP TS 32.615, particularly chapter 4.1, and chapter 4.3, pages 12-13 showing an XML example of how data provided by the Northbound NMS interface may look. Mapping means 1 are provided for mapping for example over an external third party interface 10 input UML representation of the information model of the NMS system for example expressed in the 3GPP IRP standard, to an ontology model using an ontology language syntax, for example OWL. UML-OWL-mapping is for example described in “Extending the Unified Model Language for ontology development”, 2004, by K. Baclawski, M. Kokar and P. Kogut.

The system also comprises enrichment means 2 for enriching the formal ontology model obtained by the mapping means 1. In fact there might not be any enrichment means as such, but it merely relates to input in some way of information in order to semantically enrich the formal model and this can be done manually or more or less automatically or as a mixture of both. The enrichment means may hence constitute factual means or only conceptual means.

The system further comprises processing means 3 to which the mapping rules generated or provided in the mapping means 1 and the semantically enriched formal ontology model are provided. In addition thereto network instance data is fetched from the external network management interface 10, for example as Bulk XML network data from Bulk XML network data holding means 4. The processing means uses the instance data, for example the Bulk XML network data, for automatically instantiating the semantically enriched formal ontology model using the mapping rules from the mapping means 1. The obtained formal model of network data is then stored into formal model storing means 5, and provides a new external interface, referred to as the semantically extended configuration-aware external network management interface 20 which is made available for manipulation in applications in different SOA based frameworks, here SOA 1, SOA 2, SOA 3.

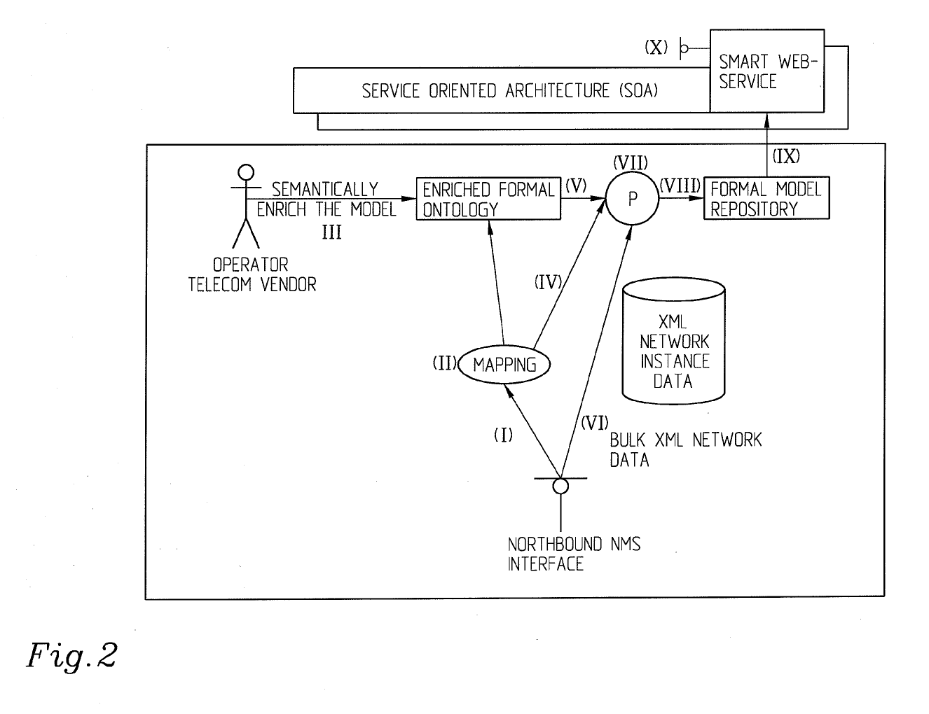

FIG. 2 is a simplified block diagram describing an implementation of the inventive concept. In a first step, an UML representation of the information model expressed in a standard, for example 3GPP IRP in a machine-readable fashion as specified by the OMG XMI standard is provided by Northbound NMS interface to mapping means, I. Based on mapping rules for example between UML and OWL, in the mapping means a base ontology is automatically generated which is derived from a high-level concept mapping of the initial UML model representation to a given ontology language syntax, such as OWL or similar, II. The mapping rules are provided to processing means P where they are stored and after that they will be used for conversion of instances of network data in a process, in processing means. Simultaneously, before, or after the step II, an enrichment of the formal ontology model obtained in the mapping step II above, is performed, III. Since knowledge about the network can-not be automatically generated, this step allows human intervention to verify and augment the ontology model generated in the mapping step. The operator can add invariants or properties, concepts or relationships depending on the required level of semantical enhancement of the data model. This may include not only network domain knowledge, but also information about how to manipulate the model to achieve a network configuration task based on formal representation of configuration workflows. This provides a semantically rich configuration-aware network management interface.

The provisioning of the ontology based workflows etc. is described in the copending patent application filed on the same day by the same applicant and with the title “A method and a system relating to a network management”, which also describes provisioning of formal ontology network model from a first basic network model, and which herewith is incorporated herein by reference.

The result of step III is an enriched ontology model derived from the basic model which is represented using the same formal ontology language as defined in step II discussed above, V. Subsequently or substantially simultaneously (or even previously) network instance data based on a standard specification, for example 3GPP Bulk XML IRP, is fetched from the Northbound NMS interface, and forwarded to the process P, VI, c.f. e.g. 3GPP SA 5 working Group TS 32.101: “Telecom Management Principles and High Level requirements v.6.0.0” also describing the Northbound NMS interface.

The instance data provided from step VI is in the process used to automatically instantiate the ontology model defined in step V. The automation is possible due to the mapping rules forwarded to the processor means in step IV as discussed above.

The instances and ontologies represented in the ontology language syntax specified in step II above, are transformed to formal logic statements, for example using description logics or frame logics. This formal representation of network data is stored into a formal model repository, VIII. The formal model repository contains the formal ontologies and the instances together. This structure, the formal repository, now contains the semantically enriched machine-readable representation of the network model, and a new interface is obtained on top of the formal model repository, providing a semantically rich configuration-aware Northbound NMS interface and hence allowing easier future Enterprise Application Integration EAI, IX. The network management information is now available for manipulation in a number of service-oriented architecture, SOA, based frameworks, X.

Hence, a number of architectural steps or processes are given which allow an easy, highly automated way to expose semantically enriched network management system Northbound interfaces for use in coming generations service-oriented architectures based on smart web services and it still does not affect the core of current implementations. This allows management systems to be easily integrated into operators' business processes without any redesign requirements on the current systems. Hence, on top of the EMS standards a richer network management model is built for interoperability or integration with smart service-oriented EAI solutions in a highly automated and flexible way without affecting the core of current NMSs.

The inventive concept can be used to facilitate Model Driven Architecture (MDA) development for NMS since it provides a formal model of the network information.

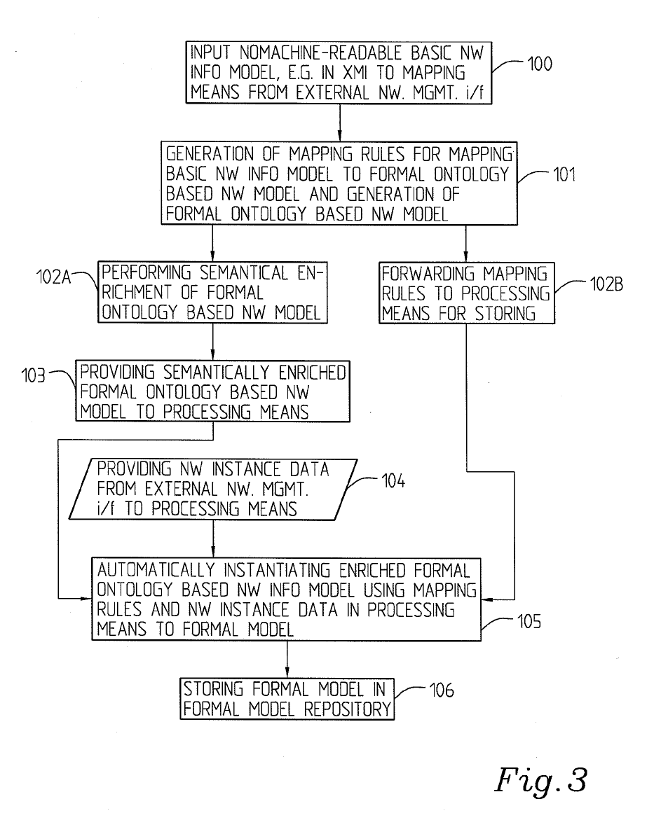

In FIG. 3 the basic steps for providing the network information representation according to the invention are illustrated in the form of a flow diagram.

First, a machine-readable basic software network information model, for example in XMI, is input to mapping means from an external network management interface, for example a Northbound NMS interface, 100. Mapping rules are generated or fetched for mapping a basic network information model to a formal ontology based network model, 101. Then a semantical enrichment of the formal ontology based network model is performed in any appropriate manner, 102A. After that, simultaneously, or before that, the mapping rules established in the mapping means or fetched to the mapping means, are forwarded to a processing means for storing and later reuse, 102B. However, after the semantical enrichment corresponding to step 102A, a semantically enriched formal ontology based network model is provided to the processing means, 103. Network instance data is also provided over the external network management interface, for example the (conventional) Northbound NMS interface, 104. This can be done before, after or simultaneously with step 103. Subsequently there is performed an automatical instantiation of the enriched formal ontology based network information model using the mapping rules and network instance data in the processing means to a formal network information model, 105. The formal model is then stored in a formal model repository, 106.

It should be clear that the invention can be varied in a number of ways within the scope of the appended claims and it is not limited to any particular known interfaces or any particular generic markup language etc. but any similar, corresponding interface, markup language etc. can be used.

According to the invention an architecture and a method are provided which allow current CORBA/XML Northbound interfaces (and other similar interfaces as well) of network management systems to expose semantically rich network information for use by smart web service oriented architectures based on web services and semantic web technologies in an automated way.

1-24. (canceled)

25. A system for representing network management information, the system having a network management system represented through a machine-readable basic network information model that includes one or more network elements, each network element having one or more managed objects with managed object instances, the system comprising:
an external network management interface comprising a first mapping component configured to generate or fetch mapping rules to use in mapping a machine-readable basic network information model to a formal ontology based network information model;
an information enrichment component configured to manually and/or automatically semantically enrich the information of the formal ontology based information model to provide a semantically enriched formal ontology based network information model;
a processing component configured to:
receive the mapping rules from the first mapping component, network instance data represented by a generic mark-up language from the external network management interface, and the semantically enriched formal ontology based network information model;
automatically instantiate the semantically enriched formal ontology based network information model using the mapping rules; and
transform the semantically enriched formal ontology based network information model comprising instances and ontologies to formal logic statements; and
a formal model storing component configured to store the formal logic statements, and including a semantically enriched machine-readable representation of the network management system information model, thus forming a semantically extended configuration-aware external network management interface.

26. The system of claim 25 wherein the machine-readable basic network information model comprises a Unified Modeling Language (UML) information model representation.

27. The system of claim 26 wherein the UML information model representation is exchangeable with the Object Management Group (OMG) XML Metadata Interchange (XMI) standard.

28. The system of claim 26 wherein the first mapping component is configured to map the UML information model representation to a given ontology language syntax.

29. The system of claim 28 wherein the ontology language syntax comprises an Ontology Web Language (OWL) syntax.

30. The system of claim 25 wherein the information enrichment component is further configured to add information invariants on properties, concepts, and/or relationships comprising network domain information.

31. The system of claim 30 wherein the added information further comprises network model manipulation information to be used for configuration task workflow generation.

32. The system of claim 25 wherein the network instance data is represented based on a 3^{rd} Generation Partnership Project (3GPP) Bulk eXtensible Markup Language (XML) Integration Reference Point (IRP).

33. The system of claim 25 wherein the external network management interface comprises a Northbound Network Management System (NMS) interface.

34. The system of claim 25 wherein the formal logic statements representing the instances and ontologies in the ontology language syntax are expressed using Description Logics.

35. The system of claim 25 wherein the formal logic statements representing the instances and ontologies in the ontology language syntax are expressed using Frame Logic (F-logic).

36. The system of claim 25 wherein the semantically extended configuration-aware external network management interface is configured to function as a bridge between the network management system and one or more external service-oriented architectures.

37. A method of representing network management information of a network management system represented by a machine-readable basic network information model having one or more network elements, each network element having one or more managed objects with managed object instances, and further having an external network management interface, the method comprising:
providing a machine-readable representation of a basic network information model from an external third-party interface to a first mapping component;
generating or fetching mapping rules used in mapping the representation of the basic network information model to a formal ontology based network information model in a given ontology language syntax;
forwarding the mapping rules to a processing component;
storing the mapping rules at the processing component;
semantically enriching the formal ontology based model to provide an enriched formal ontology based network information model;
providing the enriched formal ontology based network information model to the processing component;
providing network instance data from an external network management interface to the processing component;
using the mapping rules and the network instance data stored at the processing component to automatically instantiate the enriched formal ontology based network information model in the processing component, thereby providing a formal representation of the network data; and
storing the formal representation of the network data in a formal model storing component to form a semantically extended, configuration-aware external network management interface.

38. The method of claim 37 wherein the machine-readable basic network information model comprises a representation of a Unified Modeling Language (UML) information model.

39. The method of claim 38 wherein the UML information model representation is formatted according to an Object Management Group (OMG) XML Metadata Interchange (XMI) standard.

40. The method of claim 39 wherein generating or fetching the mapping rules comprises mapping the UML information model representation to a given ontology language syntax.

41. The method of claim 37 wherein semantically enriching the formal ontology based model to provide an enriched formal ontology based network information model comprises adding information invariants on properties, concepts, and/or relationships comprising network domain information.

42. The method of claim 41 wherein semantically enriching the formal ontology based model further comprises adding network model manipulation information for generation of configuration task workflows.

43. The method of claim 37 wherein the network instance data comprises Bulk eXtensible Markup Language (XML) data.

44. The method of claim 37 wherein the external network management interface comprises a Northbound Network Management System (NMS) interface.

45. The method of claim 37 further comprising expressing the formal logic statements representing the instances and ontologies in the ontology language syntax using Description Logics at the processing component.

46. The method of claim 37 further comprising expressing the formal logic statements representing the instances and ontologies in the ontology language syntax using Frame Logic (F-Logic) at the processing component.

47. The method of claim 37 further comprising storing the formal representation of the network data expressed in formal logic statements in a formal model storing component to provide a semantically enriched machine-readable network model representation.

48. The method of claim 47 further comprising providing a bridge between the network management system and external service-oriented architectures using the enriched machine-readable network model representation as a semantically extended, configuration-aware external network management interface.
